(19) United States
(12) Patent Application Publication
(10) Pub. No.: US 2009/0207448 A1
(43) Pub. Date: Aug. 20, 2009

(54) Communication Terminal Device and Communication System

(75) Inventor: Tomofumi TAKAGI, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA KIKAI KABUSHIKI KAISHA, Kyoto-shi, (JP)

(21) Appl. No.: 12/406,539

(22) Filed: Mar. 18, 2009

Related U.S. Application Data
(62) Division of application No. 11/202,926, filed on Aug. 12, 2005.

(30) Foreign Application Priority Data
Sep. 9, 2004 (JP) 2004-261787
Sep. 9, 2004 (JP) 2004-262122

(51) Int. Cl. G06F 3/12; G06F 17/30; G06F 15/16

(52) U.S. Cl. 358/1.15; 707/204; 709/206; 709/217

(57) ABSTRACT

A communication terminal device includes a communication unit, an archive determination unit, an archive data creating unit and an interface unit. The communication unit receives data from another communication terminal device. The archive determination unit searches whether or not archive information is included in the data received by the communication unit to determine whether or not the received data is archive data. When the archive determination unit determines that the data is not archive data, the archive data creating unit processes the data into archive data by adding archive information to the data. The interface unit transmits the archive data to another different communication terminal device.

### BACKGROUND OF THE INVENTION

1. Field of the Invention

The present invention relates to a communication terminal device and a communication system.

2. Description of Related Art

Accompanying the spread of network technology, for example, information equipment, such as a facsimile machine and a Multi-Function Peripheral (MFP), are connected to a network. The facsimile machine includes a general G3 facsimile communication function. The facsimile machine also includes a function for transmitting and receiving e-mail and an Internet fax function for transmitting and receiving image data of an original document or the like via the network. The facsimile machine can carry out transmission and reception of information with another facsimile machine, a computer and an Internet fax machine or the like.

Among communication terminal devices connected to the network, recent developments are made especially on a communication terminal device, which receives data of FAX or mail and carries out a FAX transmission or a mail transmission of the received data to another communication terminal device to back up (archive) the data.

The following Internet facsimile machine is an example of a conventional communication terminal device having such an archive function. The Internet facsimile machine includes a function for archiving transmitted or received image data by transmitting the image data to a prescribed archive mail address. The Internet facsimile machine includes a designation unit for designating archive setting information for each communication type of the transmitted or received image data, and an archive unit for archiving the transmitted or received image data according to the designation made by the designation unit. Therefore, according to such an Internet facsimile machine, the image data can be archived in accordance with an intention of an operator for each communication, and operation and management of the archived image data can be carried out efficiently.

The following Internet facsimile machine is another example of the conventional communication terminal device connected to the network. The Internet facsimile machine is an Internet facsimile machine, which transmits image data as an attached file of electronic mail, and includes a broadcast unit for carrying out broadcast transmission to a designated destination and a prescribed archive mail address. Therefore, according to such an Internet facsimile machine, contents of the transmitted image data can be confirmed later. The transmitted image data is stored in a storage unit or the like of a terminal or the like of an archiving destination. Therefore, a storage capacity of the Internet facsimile machine itself is not required to be increased for storing the image data. In addition, the storage capacity for storing the image data can be secured relatively economically. Furthermore, even when the Internet facsimile machine breaks down, since the image data or the like is stored at the archiving destination, the image data is less likely to be lost.

However, according to the above-described conventional technology, when a certain communication terminal device is designated as an archiving destination of another communication terminal device and the communication terminal device is set to carry out an archive processing to another different communication terminal device, the archive processing is carried out additionally on archive data. Therefore, there still exists room for improvement in efficiency of the archive processing carried out by the communication terminal device.

According to the above-described conventional technology, an archive transmission is carried out with data that is the same as the received data. Therefore, an operator of a communication terminal device at an archiving destination has difficulty in determining whether the data has been transmitted for a general purpose or the data has been transmitted for a purpose of archive.

### SUMMARY OF THE INVENTION

The present invention has been made in consideration of the above-described circumstances. A first advantage of the present invention is to provide a communication terminal device which can carry out an archive processing efficiently.

A second advantage of the present invention is to provide technology for creating archive data, which can be distinguished easily as the archive data by an operator of a device at an archiving destination.

To accomplish the first advantage of the present invention, according to an aspect of the present invention, a communication terminal device includes a receiving unit, an archive determination unit, an archive data creating unit and a transfer unit. The receiving unit receives data from a remote device. The archive determination unit determines whether or not the data received by the receiving unit is archive data. When the archive determination unit determines that the received data is not the archive data, the archive data creating unit processes the data into the archive data by adding archive information to the data. The transfer unit transfers the archive data to another remote device.

According to this aspect, since the transfer unit transfers the archive data in which the archive information is added in the data, an archiving destination can distinguish the archive information. Therefore, when the received data is the archive data, by controlling the archive processing to be not carried out again at the archiving destination, the archive processing can be prevented from being carried out additionally on the archive data. As a result, the communication terminal device can carry out the archive processing efficiently.

According to another aspect of the present invention, a communication terminal device includes a receiving unit, an archive determination unit, an archive data creating unit and a transfer unit. The receiving unit receives data from a remote device. The archive determination unit determines whether or not the data received by the receiving unit is archive data by searching whether or not the received data includes archive information. When the archive determination unit determines that the received data is not the archive data, the archive data creating unit processes the data into archive data. The transfer unit transfers the archive data to another remote device.

According to this aspect, the archive determination unit of the communication terminal device can determine whether or not the received data is the archive data by distinguishing whether or not the received data includes the archive information. When the received data is the archive data, by controlling the archive processing to be not carried out again, the archive processing can be prevented from being carried out additionally on the archive data. As a result, the communication terminal device can carry out the archive processing efficiently.

According to another aspect of the present invention, a communication system includes a first communication terminal device, a second communication terminal device and a communication path connecting the first communication terminal device and the second communication terminal device. The first communication terminal device and the second communication terminal device are both the above-described communication terminal device. When the first communication terminal device determines that data received from a remote device is not archive data, the first communication terminal device processes the data into the archive data and transfers the archive data via the communication path to the second communication terminal device.

According to this aspect, when the first communication terminal device determines that the data received from the remote device is not the archive data, the first communication terminal device processes the received data into the archive data and transmits the archive data via the communication path to the second communication terminal device. Therefore, the second communication terminal device at an archiving destination can determine whether or not the received data is the archive data. When the received data is the archive data, by controlling the archive processing to be not carried out again at the second communication terminal device, the archive processing can be prevented from being carried out additionally on the archive data. As a result, the communication system can carry out the archive processing efficiently.

To accomplish the second advantage of the present invention, according to an aspect of the present invention, a communication terminal device includes a receiving unit, an archive data creating unit and a transfer unit. The receiving unit receives data from a remote device. The archive data creating unit processes the data into archive data by adding archive information to the data. The transfer unit transfers the archive data to another remote device. The archive data creating unit is configured to add the archive information to the data such that the archive information is output visibly at a transfer destination of the archive data.

According to this aspect, the archive information is added to the data such that the archive information is output visibly at the transfer destination of the archive data. Therefore, an operator of a machine at a transmission destination of the archive data can easily distinguish that the received data is the archive data. The present invention provides a communication terminal device, which creates archive data that can be distinguished easily by an operator of a machine at an archiving destination.

According to another aspect of the present invention, a communication system includes a first communication terminal device, a second communication terminal device and a communication path connecting the first communication terminal device and the second communication terminal device. The first communication terminal device is the above-described communication terminal device. The first communication terminal device processes data received from a remote device into archive data and transfers the archive data via the communication path to the second communication terminal device. The second communication terminal device outputs the archive data received from the first communication terminal device under a state in which archive information included in the archive data is visible.

According to this aspect, the archive information included in the archive data is output visibly at a transfer destination of the archive data. Therefore, an operator of a machine at a transmission destination of the archive data can easily distinguish that the received data is the archive data. The present invention provides a communication system, which creates archive data that can be distinguished easily by an operator of, a machine at an archiving destination.

According to the present invention, since archive data having a specific structure is used, the present invention can provide a communication terminal device that can carry out an archive processing efficiently.

According to the present invention, since archive information is added to data under a specific format, archive data, which can be distinguished easily as the archive data by an operator of a machine at an archiving destination, can be created.

### BRIEF DESCRIPTION OF THE SEVERAL VIEWS OF THE DRAWINGS

FIG. 1 is a functional block diagram showing a network configuration of a communication terminal device according to a first embodiment and a second embodiment of the present invention.

FIG. 2 is a functional block diagram showing a configuration of a control unit of the communication terminal device according to the first embodiment of the present invention.

FIG. 3 is a flowchart for describing an operation of the communication terminal device according to the first embodiment of the present invention.

FIG. 4 is a flowchart for describing an operation of the communication terminal device according to the first embodiment of the present invention.

FIG. 5A and FIG. 53 show data structure of data based on a communication protocol of a FAX method of the communication terminal device according to the first embodiment of the present invention.

FIG. 6 shows data structure of data based on a communication protocol of an electronic mail method of the communication terminal device according to the first embodiment of the present invention.

FIG. 7 is a functional block diagram showing a configuration of a control unit of the communication terminal device according to the second embodiment of the present invention.

FIG. 8 is a flowchart for describing an operation of the communication terminal device according to the second embodiment of the present invention.

FIG. 9A and FIG. 9B show data structure of archive data created by an archive data creating unit of the communication terminal device according to the second embodiment of the present invention.

### DETAILED DESCRIPTION OF THE INVENTION

### First Embodiment

To accomplish the first advantage of the present invention, a communication terminal device according to the present invention is a multi-function communication terminal device having a facsimile function and an electronic mail function. The archive data creating unit includes a communication method determination unit, a facsimile control signal writing unit and a mail header writing unit. The communication method determination unit determines a communication method for a remote device. When the communication method determination unit determines that the communication method is a facsimile method, the facsimile control signal writing unit writes archive information into an area for writing a facsimile control signal provided in data. When the communication method determination unit determines that the communication method is an electronic mail method, the mail header writing unit writes archive information into an area for writing a mail header provided in the data.

According to this aspect, when the communication method for an archiving destination is the facsimile method, the archive information can be written in the facsimile control signal and transferred. When the communication method for the archiving destination is the electronic mail method, the archive information can be written in the mail header and transferred. Therefore, when the archiving destination distinguishes the archive information and determines that the received data is the archive data, by controlling the archive processing to be not carried out again, the archive processing can be prevented from being carried out additionally on the archive data.

According to another aspect of the present invention, an area for writing a nonstandard signal is provided in the area for writing the facsimile control signal provided in the data. The facsimile control signal writing unit is configured to write the archive information into the area for writing the nonstandard signal.

According to this aspect, the communication terminal device of the archiving destination can distinguish whether or not the received data is the archive data just by searching the area for the nonstandard signal among the facsimile control signal provided in the received data.

According to another aspect of the present invention, an area for writing the archive information is provided in the area for writing the mail header. The mail header writing unit is configured to write the archive information into the area for writing the archive information.

According to this aspect, the communication terminal device of the archiving destination can distinguish whether or not the received data is the archive data just by searching the area for writing the archive information provided in the mail header of the data.

According to another aspect of the present invention, in the communication terminal device, an archive determination unit includes a data type determination unit, a facsimile control signal determination unit and a mail header determination unit. The data type determination unit determines a type of a communication method of data. When the data type determination unit determines that the communication method is the facsimile method, the facsimile control signal determination unit searches whether or not the archive information is included in the area where the facsimile control signal of data is written. When the data type determination unit determines that the communication method is the electronic mail method, the mail header determination unit searches whether or not the archive information is included in the area where the mail header of the data is written.

According to this aspect, when the communication method of the received data is the facsimile method, by searching whether or not the archive information is included in the area where the facsimile control signal of the data is written, a determination can be made as to whether or not the received data is the archive data. When the communication method of the received data is the electronic mail method, by searching whether or not the archive information is included in the area where the mail header is written, a determination can be made as to whether or not the received data is the archive data. Therefore, when the archive information is distinguished and a determination is made that the received data is the archive data, by controlling the archive processing to be not carried out again, the archive processing can be prevented from being carried out additionally on the archive data.

According to another aspect of the present invention, an area where a nonstandard signal is written is provided in the area in the data where the facsimile control signal data is written. The facsimile control signal determination unit is configured to search whether or not the archive information is included in the area where the nonstandard signal is written.

According to this aspect, just by searching the area in the received data where the nonstandard signal among the facsimile control signal is written, a determination can be made as to whether or not the received data is the archive data.

According to another aspect of the present invention, an area where the archive information is written is provided in the area where the mail header is written. The mail header determination unit is configured to search whether or not the archive information is included in the area where the archive information is written.

According to this aspect, just by searching the area in the mail header of the received data where the archive information is written, a determination can be made as to whether or not the received data is the archive data.

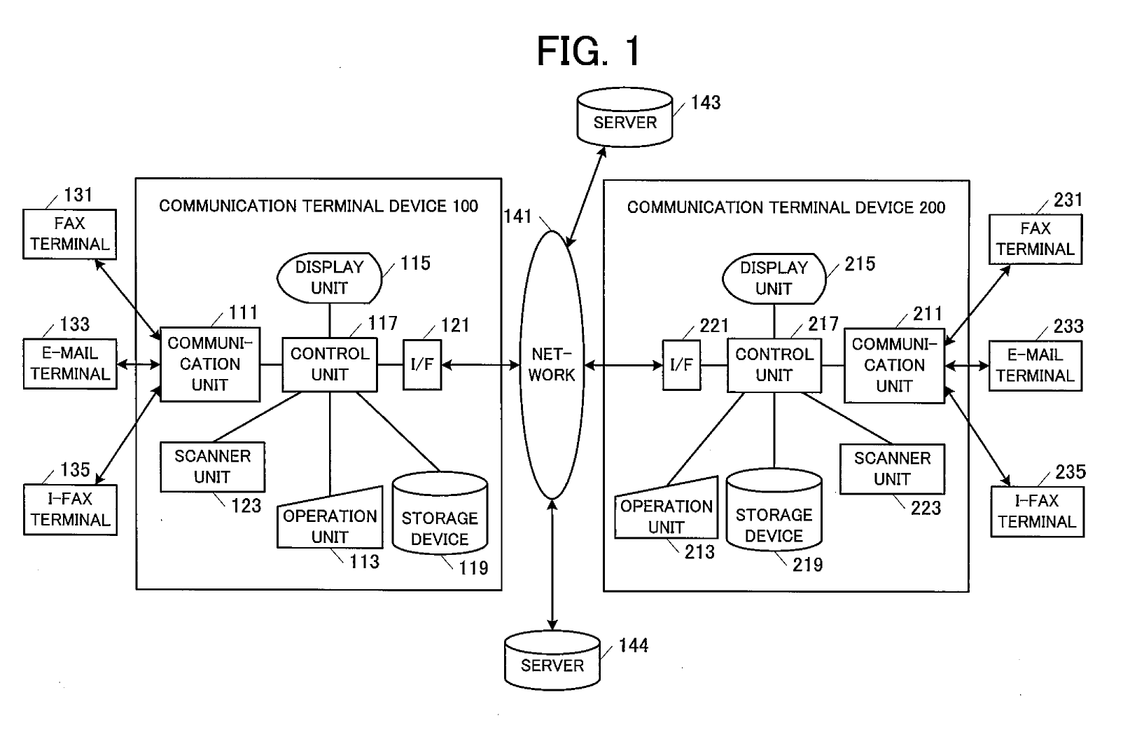

Referring to FIG. 1 through FIG. 6, a first embodiment of the present invention will be described. In the drawings, same reference numerals are applied to similar components, and redundant description will be omitted as appropriate.

FIG. 1 is a block diagram showing a network configuration of a communication terminal device according to one embodiment. For example, communication terminal devices 100 and 200 are facsimile machines or MFPS. The communication terminal devices 100 and 200 are connected to one another via a network 141. The communication terminal devices 100 and 200 are also connected to a plurality of servers 143 and 144 via the network 141, respectively.

Each component of the communication terminal devices 100 and 200 is realized primarily by a Central Processing Unit (CPU) of any computer, a memory, a program that realizes components shown in the drawing loaded to the memory, a storage unit such as hard disk that stores the program, and an interface for establishing a connection with the network, by any combination of hardware and software. It is understood by those skilled in the art that various changes and modifications can be made for methods and devices for realizing each component of the communication terminal devices 100 and 200. Each of the drawings to be described hereinafter shows blocks representing units of function, instead of units of hardware.

The communication terminal devices 100 and 200 can carry out communication by a plurality of communication methods with another communication terminal device, respectively. For example, the communication terminal devices 100 and 200 can carry out communication with FAX (fax or facsimile) terminals 131 and 231, e-mail (e-mail or electronic mail) terminals 133 and 233, and I-FAX (Internet fax) terminals 135 and 235, respectively. The FAX terminals 131 and 231 are other G3 fax terminals that carry out communication through a Public Switched Telephone Network (PSTN). The e-mail terminals 133 and 233 and the I-FAX terminals 135 and 235 are other computers and other Internet fax terminals or the like that carry out communication through a network, such as the Internet.

Specifically, the communication terminal device 100 includes a communication unit 111, a display unit 115, a control unit 117, a storage device 119, an operation unit 113, an interface unit 121 and a scanner unit 123. The communication terminal device 200 includes a communication unit 211, a display unit 215, a control unit 217, a storage device 219, an operation unit 213, an interface unit 221 and a scanner unit 223. In FIG. 1, components that are unrelated to the subject matter of the present invention are omitted, For example, an image processing unit and a printer unit, which are general components of a facsimile machine, are not shown in FIG. 1.

The communication unit 111, 211 (a transmitting unit or a receiving unit) carries out communication with the FAX terminal 131, 231, the e-mail terminal 133, 233 and the I-FAX terminal 135, 235 (another communication terminal device), respectively. The operation units 113 and 213 are, for example, an operation button, a switch, a lever, a keyboard, a touch screen or the like. The display units 115 and 215 display various pieces of information and an operation screen. The display units 115 and 215 also display an operation status of the communication terminal devices 100 and 200, respectively. The display units 115 and 215 are, for example, a lamp, a Light Emitting Diode (LED), a Cathode Ray Tube (CRT) monitor or a Liquid Crystal Display (LCD).

The control units 117 and 217 control each component of the communication terminal devices 100 and 200 and the entire communication terminal devices 100 and 200, respectively. The storage devices 119 and 219 may include a storage area for storing information, such as a telephone directory. The interface units 121 and 221 are connected to one another via the network 141 and carry out communication with one another. The interface units 121 and 221 carry out communication with a plurality of servers 143 and 144 connected via the network 141.

Further, the network 141 can be a network, which carries out data communication by either one of a facsimile method, an electronic mail method and other methods. Further, although the communication method may be the Internet facsimile method, among the Internet facsimile method, a method that uses electronic mail is included in the electronic mail method. That is, the network may be any one of the PSTN, a Local Area Network (LAN), a Wide Area Network (WAN) and other communication networks.

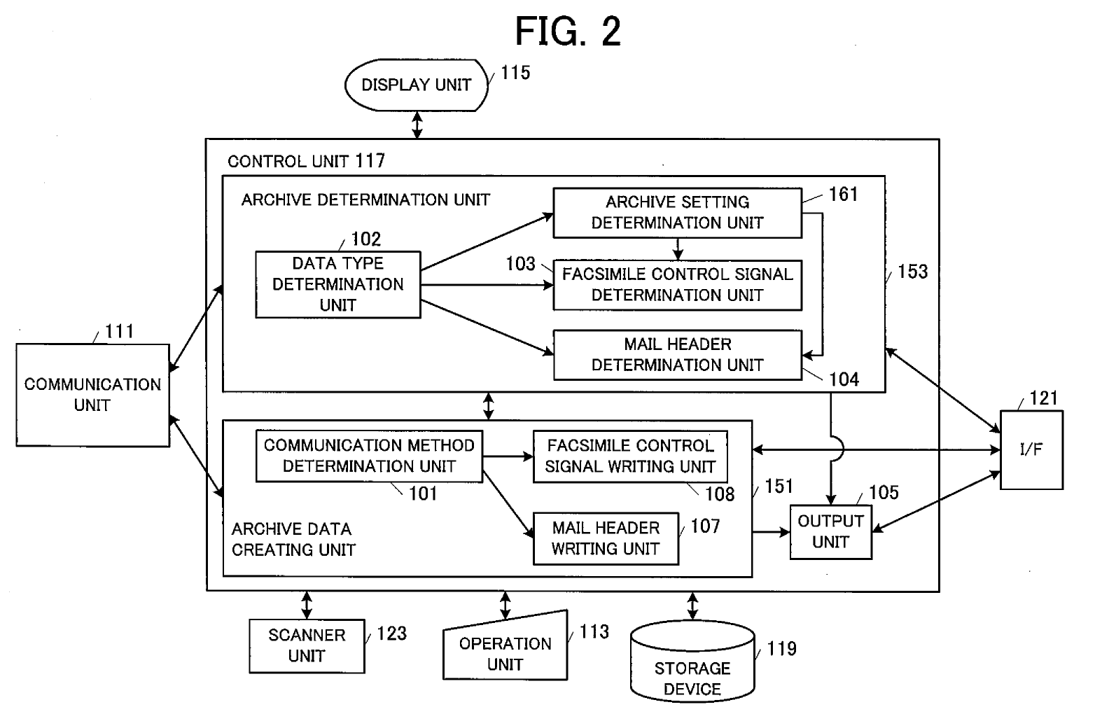

FIG. 2 is a functional block diagram of the control unit 117 of the communication terminal device 100 of FIG. 1. Further, the control unit 217 of the communication terminal device 200 has the same configuration as the control unit 117 of the communication terminal device 10. Since the description overlaps, a description of the control unit 217 of the communication terminal device 200 with reference to the drawings will be omitted. The control unit 117 of the communication terminal device 100 includes an archive determination unit 153, an archive data creating unit 151 and an output unit 105.

The archive determination unit 153 includes an archive setting determination unit 161, a data type determination unit 102, a facsimile control signal determination unit 103 and a mail header determination unit 104. The archive determination unit 153 determines whether or not received data received by the communication unit 111 is archive data by searching whether or not archive information is included in a communication information area of the received data received by the communication unit 111 (an area where a signal based on a communication protocol is written).

In this case, the data type determination unit 102 determines a type of a communication method of the received data received from the FAX terminal 131, the e-mail terminal 133 and the I-FAX terminal 135 or the like. When the data type determination unit 102 determines that the communication method of the received data is the facsimile method, the facsimile control signal determination unit 103 searches a facsimile control signal of the received data and determines whether or not the received data is the archive data. When the data type determination unit 102 determines that the communication method of the received data is the electronic mail method, the mail header determination unit 104 searches a mail header of the received data and determines whether or not the received data is the archive data.

The archive data creating unit 151 includes a communication method determination unit 101, a facsimile control signal writing unit 108 and a mail header writing unit 107. When the archive determination unit 153 determines that the received data is not the archive data, the archive data creating unit 151 processes the received data into the archive data by adding archive information to the communication information area of the received data in accordance with the determination result obtained from the archive determination unit 153. Then, the archive data creating unit 151 transfers the archive data to another communication terminal device 200 via the interface unit 121, which is a transfer unit, and the network 141.

In this case, the communication method determination unit 101 determines the communication method for the other communication terminal device 200. When the communication method determination unit 101 determines that the communication method for the other communication terminal device 200 is the facsimile method, the facsimile control signal writing unit 108 writes an indication indicating that transmission data is the archive data into the facsimile control signal of the transmission data in accordance with the determination result obtained from the communication method determination unit 101. When the communication method determination unit 101 determines that the communication method for the other communication terminal device 200 is the electronic mail method, the mail header writing unit 107 writes an indication indicating that transmission data is the archive data into the mail header of the transmission data in accordance with the determination result obtained from the communication method determination unit 101.

The output unit 105 outputs the received data in accordance with the determination result obtained from the archive determination unit 153. In this case, the output unit 105 outputs the received data to, for example, a printer unit (not shown), the display unit 115 or a fax data storage unit (not shown) of the servers 143 and 144 according to a setting.

Next, a detailed description will be made of an operation of the communication terminal device according to the present embodiment. Further, the communication terminal device 200 carries out the same operation as the communication terminal device 100. Since the description overlaps, a description of the operation carried out by the communication terminal device 200 with reference to the drawings will be omitted.

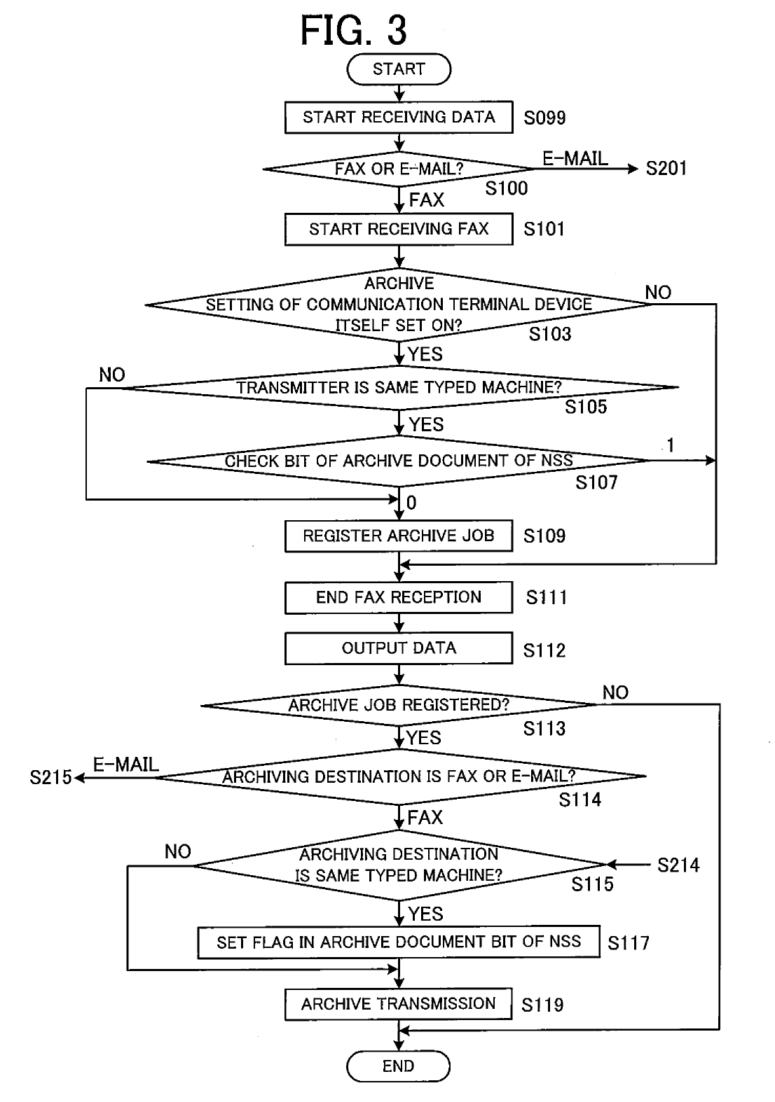

FIG. 3 is a flowchart for describing the operation of the communication terminal device according to one embodiment. When the communication unit 111 of the communication terminal device 100 starts receiving data from the FAX terminal 131, the e-mail terminal 133 or the I-FAX terminal 135 (step S099), the communication unit 111 transmits the received data to the data type determination unit 102. The data type determination unit 102, which obtained the received data, determines whether the communication information area of the received data is a communication information area of either one of FAX data and e-mail data (step S100). Then, the data type determination unit 102 transmits the received data and the determination result to the communication unit 111.

When the data type determination unit 102 determines that a signal based on a communication protocol of the FAX data is written in the communication information area of the received data, the communication unit 111, which obtained the received data and the determination result, starts receiving remaining FAX data main body in addition to the communication information area (step S101). Then, the communication unit 111 transmits the received data and the determination result to the archive setting determination unit 161. Meanwhile, when the data type determination unit 102 determines that a signal based on a communication protocol of the e-mail data is written in the communication information area of the received data, the communication unit 111 proceeds onto step S201.

The archive setting determination unit 161, which obtained the received data and the determination result, accesses to the storage device 119, which stores archive setting of the communication terminal device 100 itself, and reads whether the archive setting is set ON or OFF (step S103). When the archive setting determination unit 161 determines that the archive setting is set ON, the archive setting determination unit 161 transmits the received data and the determination result to the facsimile control signal determination unit 103. Meanwhile, when the archive setting determination unit 161 determines that the archive setting is set OFF, the archive setting determination unit 161 transmits a determination result to the communication unit 111 to proceed onto a step of ending the FAX reception (step S111), without transmitting the received data and the determination result to the facsimile control signal determination unit 103.

The facsimile control signal determination unit 103, which obtained the received data and the determination result, reads the communication information area of the received data, and determines whether or not a transmitter of the received data is a same typed machine that displays the archive information in a Nonstandard Facilities Setup (NSS) area of the facsimile control signal (step S105). Further, the same typed machine is a machine manufactured by same manufacturer.

Meanwhile, when the facsimile control signal determination unit 103 determines that the transmitter is not the same typed machine that displays the archive information in the NSS area of the facsimile control signal (determines that whether or not the received data is the archive data is unclear), the facsimile control signal determination unit 103 registers an archive job in the storage device 119 (step S109).

When the facsimile control signal determination unit 103 determines that the transmitter is the same typed machine that displays the archive information in the NSS area of the facsimile control signal, the facsimile control signal determination unit 103 checks whether or not a flag is set in a bit, which indicates that the received data is an archive document (archive data), in the NSS area of the communication information area of the received data (step S107).

As a result of checking, when the archive bit is “0” (when a flag is not set and the result indicates that the received data is not the archive data), the facsimile control signal determination unit 103 registers the archive job in the storage device 119 (step S109), and transmits a determination result to the communication unit 111 to proceed onto a step of ending the FAX reception (step S111).

Meanwhile, as a result of checking, when the archive bit is “1” (when a flag is set and the result indicates that the received data is the archive data), the facsimile control signal determination unit 103 does not register an archive job in the storage device 119, and transmits a determination result to the communication unit 111 to proceed onto the step of ending the FAX reception (step S111).

When the FAX reception ends (step S111), the communication unit 111, which obtained the determination result, transmits the remaining received data to the archive determination unit 153. The archive determination unit 153 transmits to the output unit 105, the entire received data including a control information area of the already obtained received data and data main body of newly obtained received data (step S112).

The output unit 105, which obtained the received data, prints out the received data in the same manner as when printing out normal FAX data.

Furthermore, the archive determination unit 153 searches whether or not an archive job is registered in the storage device 119 (step S113). When the archive job is registered in the storage device 119, the archive determination unit 153 transmits the received data and the determination result to the communication method determination unit 101 of the archive data creating unit 151. Meanwhile, when the archive job is not registered in the storage device 119, the archive determination unit 153 transmits a signal indicating such a fact to the control unit 117. The control unit 117, which obtained the signal, ends a series of the processes of the communication terminal device 100 without carrying out the archive processing by the communication terminal device 100.

The communication method determination unit 101, which obtained the received data and the determination result, loads data stored in the storage device 119 relating to the communication method for the communication terminal device 200 of the archiving destination. The communication method determination unit 101 determines whether the communication method for the archiving destination is either one of the FAX method and the e-mail method (step S114).

When the communication method determination unit 101 determines that the communication method for the archiving destination is the FAX method, the communication method determination unit 101 loads data stored in the storage device 119 relating to a model of the communication terminal device 200 of the archiving destination. Then, the communication method determination unit 101 determines whether or not the communication terminal device 200 of the archiving destination is the same typed machine that displays the archive information in the NSS area of the facsimile control signal (step S115). Meanwhile, when the communication method determination unit 101 determines that the communication method for the archiving destination is the e-mail method, the process proceeds onto step S215.

When the communication method determination unit 101 determines that the communication terminal device 200 of the archiving destination is the same typed machine that displays the archive information in the NSS area of the facsimile control signal, the communication method determination unit 101 transmits the received data and the determination result to the facsimile control signal writing unit 108. Meanwhile, when the communication method determination unit 101 determines that the communication terminal device 200 of the archiving destination does not support the data having same type of area as the same typed machine that displays the archive information in the NSS area of the facsimile control signal, the communication method determination unit 101 transmits a signal indicating such a fact to the control unit 117. The control unit 117, which obtained the signal, ends the series of the processes carried out by the communication terminal device 100.

The facsimile control signal writing unit 108, which received the received data and the determination result, sets a flag in an archive document bit (bit indicating that the received data is the archive data) in the area of the NSS among the facsimile control signal provided in the received data (rewrites the archive document bit from “0” to “1”) (step S117). Then, the archive data creating unit 151 creates the archive data and transmits the archive data to the interface unit 121.

The interface unit 121, which obtained the archive data, transfers the archive data via the network 141 to the communication terminal device 200 (step S119). When the transfer of the archive data ends, the interface unit 121 transmits a signal indicating such a fact to the control unit 117. The control unit 117, which obtained the signal, ends the series of the processes carried out by the communication terminal device 100.

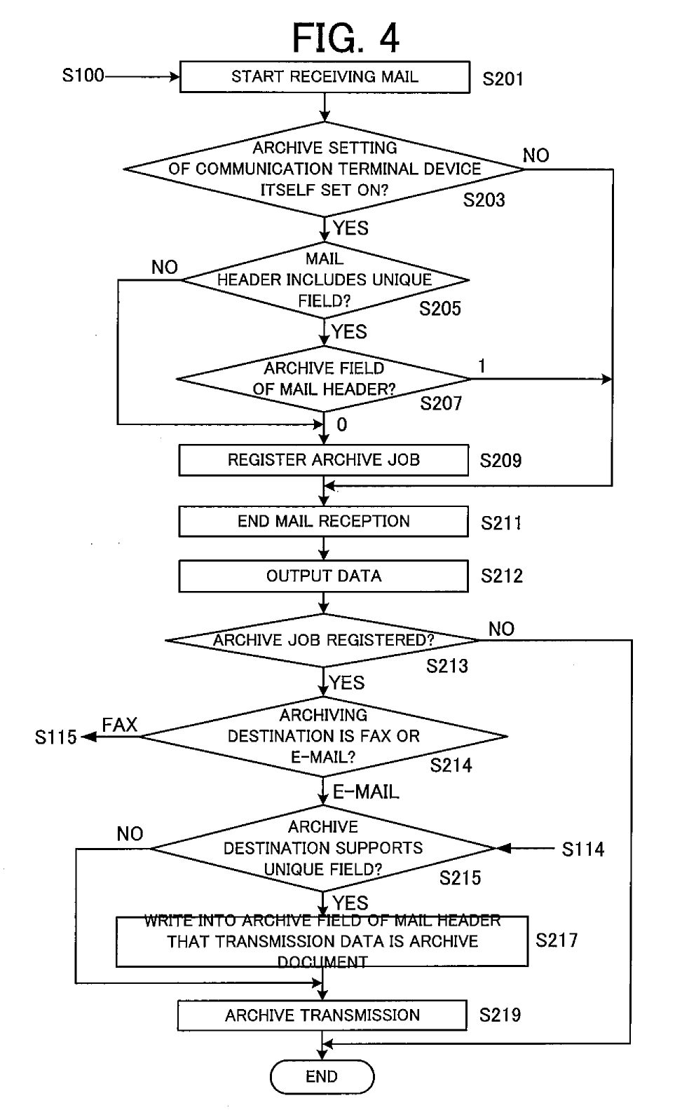

FIG. 4 is a flowchart for describing an operation of the communication terminal device according to one embodiment. When the data type determination unit 102 determines at step S100 that the signal based on the communication protocol of the e-mail data is written in the communication information area of the received data, the communication unit 111 that received the determination result starts receiving remaining e-mail data main body in addition to the data of the communication information area (step S201), and transmits the received data and the determination result to the archive setting determination unit 161.

The archive setting determination unit 161, which received the received data and the determination result, accesses to the storage device 119 in which the archive setting of the communication terminal device 100 itself is stored. The archive setting determination unit 161 reads whether the archive setting is set ON or OFF (step S203). When the archive setting determination unit 161 determines that the archive setting is set ON, the archive setting determination unit 161 transmits the received data and the determination result to the mail header determination unit 104. Meanwhile, when the archive setting determination unit 161 determines that the archive setting is set OFF, the archive setting determination unit 161 transmits a determination result to the communication unit 111 to proceed onto a step of ending the mail reception (step S211), without transmitting the received data and the determination result to the mail header determination unit 104.

The mail header determination unit 104, which obtained the received data and the determination result, reads the communication information area of the received data, and determines whether or not the transmitter of the received data is the same typed machine that displays the archive information in the mail header and that supports data having a unique field (step S205).

When the mail header determination unit 104 determines that the transmitter is the same typed machine that displays the archive information in the mail header and that supports the data having the unique field, the mail header determination unit 104 checks whether or not a flag is set in the unique field (archive field) of the communication information area of the received data (step S207).

As a result of checking, when a value of the archive field is “0” (when the flag is not set indicating that the received data is not the archive data), the mail header determination unit 104 registers the archive job in the storage device 119 (step S209). Then, the mail header determination unit 104 transmits the determination result to the communication unit 111 to proceed onto a step of ending the e-mail reception (step S211).

Meanwhile, as a result of checking, when the value of the archive field is “1” (when the flag is set indicating that the received data is the archive data), the mail header determination unit 104 transmits the determination result to the communication unit 111 to proceed onto the step of ending the mail reception (step S211), without registering the archive job in the storage device 119.

When the mail reception ends (step S211), the communication unit 111 that received the determination result transmits the remaining received data to the archive determination unit 153. The archive determination unit 153 transmits to the output unit 105, the entire received data including the control information area of the already obtained received data and data main body of newly obtained received data (step S212).

The output unit 105, which obtained the received data, prints out the received data in the same manner as when printing out the normal e-mail data (for example, data of I-FAX communicated by the e-mail method).

Furthermore, the archive determination unit 153 searches whether or not an archive job is registered in the storage device 119 (step S213). When the archive job is registered in the storage device 119, the archive determination unit 153 transmits the received data and the determination result to the communication method determination unit 101 of the archive data creating unit 151. Meanwhile, when the archive job is not registered, the archive determination unit 153 transmits a signal indicating such a fact to the control unit 117. The control unit 117, which obtained the signal, ends the series of the processes carried out by the communication terminal device 100 without carrying out the archive processing by the communication terminal device 100.

The communication method determination unit 101, which obtained the received data and the determination result, loads data stored in the storage device 119 relating to the communication method for the communication terminal device 200 of the archiving destination. The communication method determination unit 101 determines whether the communication method for the archiving destination is the FAX method or the e-mail method (step S214).

When the communication method determination unit 101 determines that the communication method for the archiving destination is the e-mail method, the communication method determination unit 101 loads the data stored in the storage device relating to a model of the communication terminal device 200 of the archiving destination. The communication method determination unit 101 determines whether or not the communication terminal device 200 of the archiving destination is the same typed machine that displays the archive information in the mail header and that supports the data having the unique field (step S215). Meanwhile, when the communication method determination unit 101 determines that the communication method for the archiving destination is the FAX method, the process proceeds onto step S115.

When the communication method determination unit 101 determines that the communication terminal device 200 of the archiving destination is the same typed machine that displays the archive information in the mail header and that supports the data having the unique field, the communication method determination unit 101 transmits the received data and the determination result to the mail header writing unit 107. Meanwhile, when the communication method determination unit 101 determines that the communication terminal device 200 of the archiving destination is the same typed machine that displays the archive information in the mail header and that supports the data having the unique field, the communication method determination unit 101 transmits a signal indicating such a fact to the control unit 117. The control unit 117, which obtained the signal, ends the series of the processes carried out by the communication terminal device 100.

The mail header writing unit 107, which obtained the received data and the determination result, sets a flag in the unique field (a field indicating that the received data is the archive document) provided in the mail header of the received data (step S217). Then, the archive data creating unit 151 creates archive data and transmits the archive data to the interface unit 121.

The interface unit 121, which obtained the archive data, transfers the archive data via the network 141 to the communication terminal device 200 (step S219). When the transfer of the archive data ends, the interface unit 121 transmits a signal indicating such a fact to the control unit 117. The control unit 117, which received the signal, ends the series of the processes carried out by the communication terminal device 100.

Next, a description will be made of the data based on the communication protocol used in one embodiment. Communication data transmitted and received by the communication terminal device 200 has the same structure as communication data transmitted and received by the communication terminal device 100. Since the description overlaps, a description of the communication data transmitted and received by the communication terminal device 200 with reference to the drawings will be omitted.

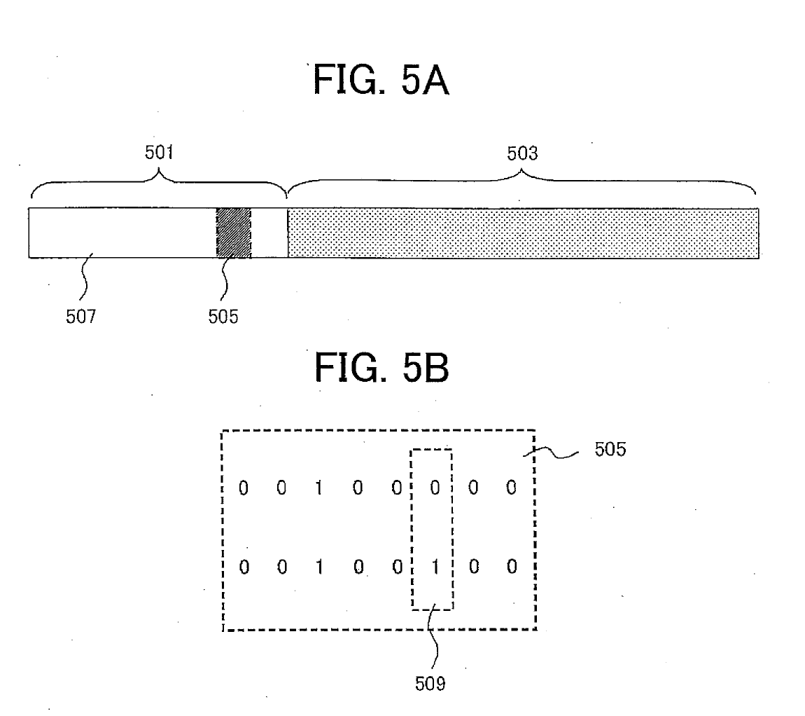

FIG. 5A and FIG. 5B show data structure of data based on the communication protocol of the FAX method of the communication terminal device according to one embodiment. As shown in FIG. 5A, communication data based on a unique communication protocol supported by the communication terminal device 100 includes a facsimile control signal 501 (control information area) and a data main body 503. The facsimile control signal 501 includes a standard signal area 507 and a NSS area 505 (nonstandard signal area). The standard signal area 507 can be defined by the International Standard. The NSS area 505 can be defined uniquely for each model by each manufacturer.

As shown in FIG. 5B, the communication data has an archive bit 509 in the NSS area 505. The archive bit 509 is a unique area that displays the archive information. An upper column of FIG. 5B shows a state in which a flag is not set in the archive bit (the archive bit 509 is “0”). A lower column of FIG. 5B shows a state in which a flag is set in the archive bit (the archive bit 509 is “1”).

Further, since the signal of the archive bit 509 is not defined currently by a standard protocol signal, a nonstandard protocol signal can be used. Further, the nonstandard protocol signal is the NSS, a signal of which usage is not defined by a recommendation of an international organization and which each manufacturer uses to realize unique function by unique usage.

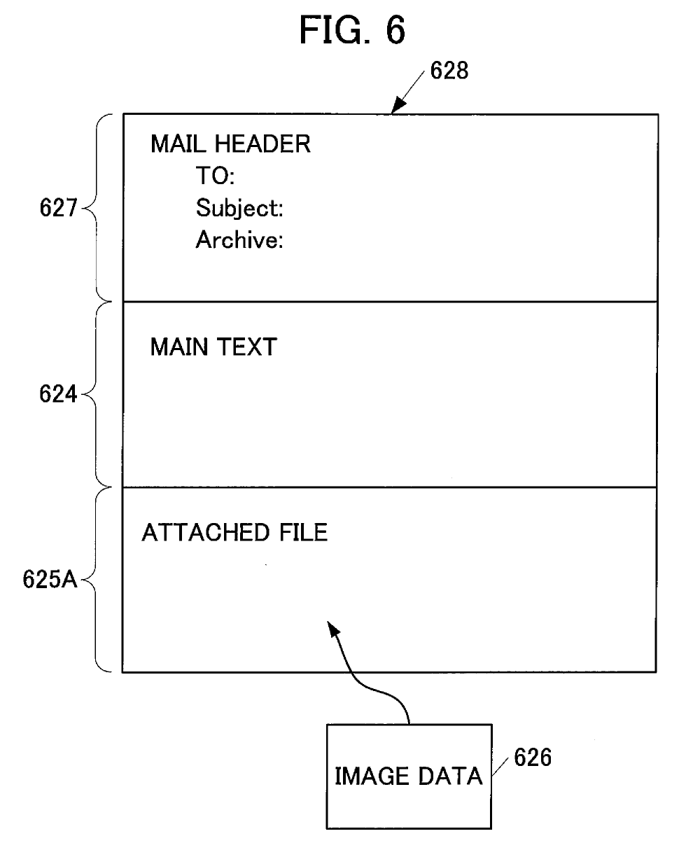

FIG. 6 shows data structure of data based on the communication protocol of the electronic mail method of the communication terminal device according to one embodiment. Communication data 628 based on the unique communication protocol supported by the communication terminal device 100 includes a mail header 627 (control information area), main text data 624 and attached file data 625A. The mail header 627 is provided with an archive field defined uniquely by each manufacturer. The attached file data 625A includes image data 626. In the following, a description will be made of operation and effect of the communication terminal device according to one embodiment.

The communication terminal devices 100 and 200 of the present embodiment can improve efficiency of the archive processing. That is, the communication terminal devices 100 and 200 include an adding unit for adding information indicating an archive to the communication information area provided in the communication data, and a recognition unit for recognizing the information indicating the archive. Therefore, when the data transmitted from the communication terminal device 100 to the communication terminal device 200 is the archive data, by controlling the archive processing to be not carried out again at the communication terminal device 200 of the archiving destination, the archive processing can be prevented from being carried out additionally on the archive data. As a result, the communication terminal devices 100 and 200 can carry out the archive processing efficiently.

The communication terminal devices 100 and 200 according to one embodiment can reduce effects resulting from the difference of the plurality of the communication methods. That is, when the communication method from the communication terminal device 100 to the communication terminal device 200 is the facsimile method, a flag can be set in the archive bit of the facsimile control signal 501, and the transmission can be carried out. When the communication method from the communication terminal device 100 to the communication terminal device 200 is the electronic mail method, a unique field can be provided in the mail header 627, and information indicating an archive can be added to the unique field and the transmission can be carried out. Therefore, by switching operations carried out at the communication terminal device 100 and the communication terminal device 200, even when the communication method is either one of the communication methods, the communication terminal device 200 of the archiving destination can distinguish the communication method. When the received data is the archive data, by controlling the archive processing to be not carried out again, the archive processing can be prevented from being carried out additionally on the archive data. As a result, effects resulting from the difference of the plurality of the communication methods can be reduced.

An embodiment of the present invention has been described with reference to the drawings. The above-described embodiment is an example of the present invention and various different configurations can be adopted.

For example, according to the above-described embodiment, the communication terminal device 100 determines the communication method for the communication terminal device 200 by obtaining model information of the communication terminal device 200 stored in the storage device 119. However, this is not an aspect to be limited in particular. For example, the communication terminal device 100 may transmit a signal to the communication terminal device 200 for obtaining the model information of the communication terminal device 200. In this case, the communication terminal device 200, which received the signal, transmits the model information of the communication terminal device 200 to the communication terminal device 100. The communication terminal device 100, which received the model information, may determine the model of the communication terminal device 200 in accordance with the received model information.

According to the above-described embodiment, the output unit 105 prints out the received data in the same manner as when printing out normal FAX data or normal e-mail data. However, this is not an aspect to be limited in particular. For example, a printing format of the output unit 105 may differ for when the received data is the archive data and when the received data is not the archive data. That is, when the received data is the archive data, the output unit 105 may not print out the received data, and when the received data is not the archive data, the output unit 105 may print out the received data. In this case, for example, the output unit 105 may record the archive data in the server 143 via the interface unit 121 and the network 141, and the archive data recorded in the server 143 may be printed out according to a request from an operator. As another example, when the received data is the archive data, the received data may be reduced by ½ times and printed out. When the received data is not the archive data, the received data may be printed out at 100% magnification. Alternatively, as another example, when the received data is the archive data, only the first page may be printed out, and when the received data is not the archive data, all of the pages may be printed out. In this case, when the received data is the archive data, a communication record may be recorded in the storage device 119, and when the received data is not the archive data, the communication record may be not recorded in the storage device 119.

### Second Embodiment

To accomplish the second advantage of the present invention, according to an aspect of the present invention, the communication terminal device is a multi-function communication terminal device having a facsimile function and an electronic mail function. An archive data creating unit includes a communication method determination unit, a facsimile document writing unit and a property writing unit. The communication method determination unit determines a communication method for a remote device. When the communication method determination unit determines that the communication method is the facsimile method, the facsimile document writing unit writes archive information into a facsimile document area of data. When the communication method determination unit determines that the communication method is the electronic mail method, the property writing unit writes archive information into a property area of the data.

According to this aspect, the communication terminal device includes a switching unit for switching a method for adding information indicating an archive according to the communication method for the archiving destination. Therefore, even when the communication method for the archiving destination is either one of the facsimile method and the electronic mail method, the archiving destination can visibly output the archive information included in the archive data.

According to another aspect of the present invention, the facsimile document writing unit includes a transmitter information writing unit for writing the archive information into a transmitter information area provided in the facsimile document area.

According to this aspect, since the archive information is written into the transmitter information area provided in the facsimile document area, a device of the archiving destination can visibly output the archive information in a transmitter information field when printing out the facsimile data.

According to another aspect of the present invention, the property writing unit includes a file name writing unit for writing the archive information into a file name area provided in the property area.

According to this aspect, since the archive information is written into the file name area provided in the property area, when a device of the archiving destination displays a file of the archive data on the LCD monitor or the like, the archive information can be output visibly in a file name field.

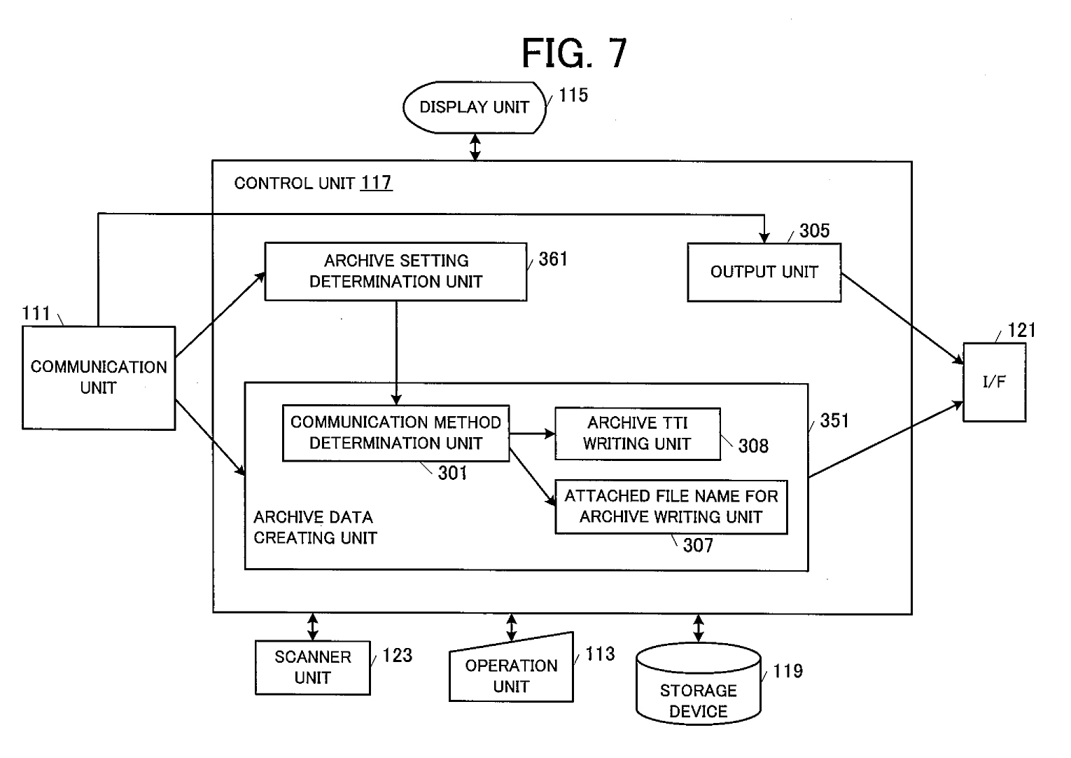

With reference to FIG. 7 through FIG. 9, the second embodiment of the present invention will be described. In the drawings, same reference numerals are applied to similar components, and redundant description will be omitted as appropriate. The block diagram showing the network configuration of the communication terminal device according to the second embodiment is the same as the first embodiment described with reference to FIG. 1. Therefore, a description with reference to the drawing will be omitted.

FIG. 7 is a functional block diagram of the control unit 117 of the communication terminal device 100 of FIG. 1. The control unit 217 of the communication terminal device 200 has the same configuration as the control unit 117 of the communication terminal device 100. Since the description overlaps, the description of the control unit 217 of the communication terminal device 200 with reference to the drawings will be omitted. The control unit 117 of the communication terminal device 100 includes an archive setting determination unit 361, an archive data creating unit 351 and an output unit 305.

When the archive setting determination unit 361 obtains a signal indicating a reception of data from the communication unit 111, the archive setting determination unit 361 accesses to an archive setting table stored in the storage device 119, and determines whether the archive setting of the communication terminal device 100 is set ON or OFF.

The archive data creating unit 351 is configured to add archive information to the received data such that the archive information is output visibly (printed out or displayed on a screen) at the communication terminal device 200, which is a transfer destination of the archive data. That is, the archive data creating unit 351 includes a communication method determination unit 301, an archive Transmit Terminal Identifier (TTI) writing unit 308 and an attached file name for archive writing unit 307. When the archive data creating unit 351 obtains the received data from the communication unit 111, the archive data creating unit 351 processes the received data into the archive data by adding the archive information to the received data. Then, the archive data creating unit 351 transfers the archive data to another communication terminal device 200 via the interface unit 121, which is a transfer unit, and the network 141.

In this case, the communication method determination unit 301 determines the communication method for another communication terminal device 200. When the communication method determination unit 301 determines that the communication method for the other communication terminal device 200 is the facsimile method, the archive TTI writing unit 308 writes an indication indicating that transmission data is the archive data into the TTI area (transmitter information area) of the transmission data in accordance with the determination result obtained from the communication method determination unit 301. When the communication method determination unit 301 determines that the communication method for the other communication terminal device 200 is the electronic mail method, the attached file name for archive writing unit 307 writes an indication indicating that the transmission data is the archive data into the file name area of the transmission data in accordance with the determination result obtained from the communication method determination unit 301.

The output unit 305 outputs the received data obtained from the communication unit 111. In this case, the output unit 305 obtains an output setting stored in the storage device 119, and for example, outputs the received data to a printer unit (not shown), the display unit 115 or a fax data storage unit (not shown) of the servers 143 and 144 according to the output setting.

Next, a description will be made of an operation of the communication terminal device according to one embodiment. The operation carried out by the communication terminal device 200 is the same as the operation carried out by the communication terminal device 100. Since the description overlaps, a description of the operation carried out by the communication terminal device 200 with reference to the drawings will be omitted.

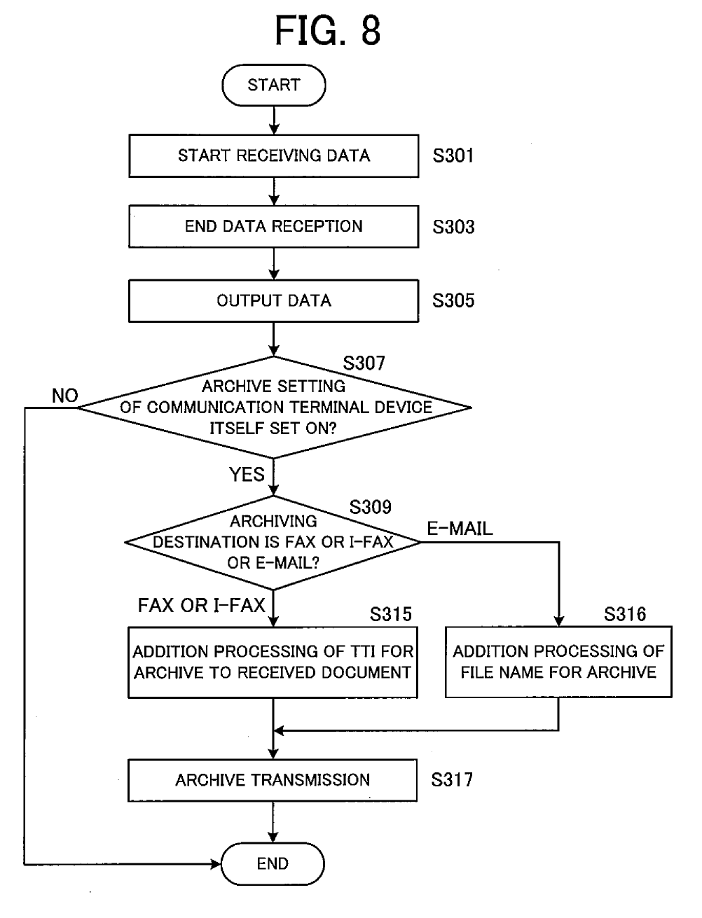

FIG. 8 is a flowchart for describing the operation of the communication terminal device according to one embodiment. When the communication unit 111 of the communication terminal device 100 starts receiving data from the FAX terminal 131, the e-mail terminal 133 or the I-FAX terminal 135 (step S301), the communication unit 111 sequentially sends the received data to the control unit 117. When the reception of the data ends (step S303) the communication unit 111 of the communication terminal device 100 sends the remaining part of the received data and a signal indicating the end of the data reception to the control unit 117.

The control unit 117, which obtained the received data and a signal indicating the end of the data reception, sends the received data to the archive setting determination unit 361 and the output unit 305. According to the data type of the received data, the output unit 305 that obtained the received data carries out an appropriate data output processing (step S305). For example, the output unit 305 prints out the received data in the same manner as when printing out the normal FAX data or the normal electronic mail data. Alternatively, the output unit 305 stores the received data in the storage device 119 and displays a fact of the reception of the data on the display unit 115.

The archive setting determination unit 361 that obtained the received data accesses to the storage device 119, which stores the archive setting of the communication terminal device 100 itself, and reads whether the archive setting is set ON or OFF (step S307). When the archive setting determination unit 361 determines that the archive setting is set ON, the archive setting determination unit 361 transmits the received data and the determination result to the archive data creating unit 351. Meanwhile, when the archive setting determination unit 361 determines that the archive setting is set OFF, the archive setting determination unit 361 transmits a signal indicating such a fact to the control unit 117 without transmitting the received data and the determination result to the communication method determination unit 301 of the archive data creating unit 351. The control unit 117 that obtained the signal ends the series of the processes carried out by the communication terminal device 100.

The communication method determination unit 301, which obtained the received data and the determination result, loads the data stored in the storage device 119 relating to the communication method for the communication terminal device 200 of the archiving destination, and determines whether the communication method for the archiving destination is either one of the FAX method, the I-FAX method and the e-mail method (step S309).

When the communication method determination unit 301 determines that the communication method for the archiving destination is the FAX method or the I-FAX method, the communication method determination unit 301 transmits the received data and the determination result to the archive TTI writing unit 308. Meanwhile, when the communication method determination unit 301 determines that the communication method for the archiving destination is the e-mail method, the communication method determination unit 301 transmits the received data and the determination result to the attached file name for archive writing unit 307.

The archive TTI writing unit 308, which received the received data and the determination result, creates the archive data by writing the archive information (information including characters of “Archive”) into a TTI area (an area for writing the transmitter information) in the facsimile document data area where the data main body is written, that is different from the facsimile control information area in the received document where the communication protocol is written (step S315). Then, the archive TTI writing unit 308 transmits the archive data to the interface unit 121.

Meanwhile, the attached file name for archive writing unit 307, which received the received data and the determination result, creates the archive data by writing the archive information (information including characters of “Archive”) into the file name area (an area for writing the file name) provided in the property area (area for writing the property information of the file) of the received data (step S316). Then, the attached file name for archive writing unit 307 transmits the archive data to the interface unit 121.

The interface unit 121, which obtained the archive data, transfers the archive data via the network 141 to the communication terminal device 200 (step S317). When the transfer of the archive data ends, the interface unit 121 transmits a signal indicating such a fact to the control unit 117. The control unit 117 that obtained the signal ends the series of the processes carried out by the communication terminal device 100.

In the following, a description will be made of data based on the communication protocol used in one embodiment. Communication data transmitted and received by the communication terminal device 200 has the same structure as communication data transmitted and received by the communication terminal device 100. Since the description overlaps, the description of the communication data transmitted and received by the communication terminal device 200 with reference to the drawings will be omitted.

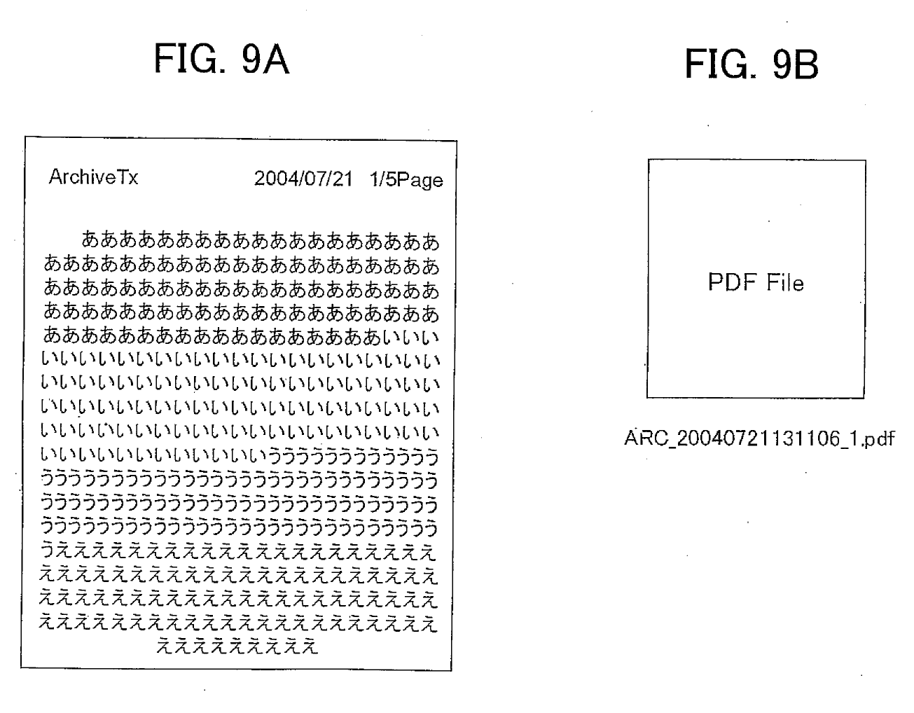

FIG. 9A and FIG. 9B are schematic diagrams for describing a structure of archive data created by the archive data creating unit 351 of the communication terminal device according to one embodiment. As shown in FIG. 9A, in the archive data created by the archive TTI writing unit 308 of the archive data creating unit 351, characters of “ArchiveTx” (archive information) are written additionally in the TTI field of the facsimile document area.

That is, to clearly specify that the transmission data for the communication terminal device 200 is for archives when the archiving destination is the FAX or the I-FAX terminal, at the archive transmission, a character string for distinguishing the transmission data as the archive is added to the original TTI. Further, in FIG. 9A, the archive information and a part of the transmitter information, which is originally written in the received data (Jul. 7, 2004 1/5 page), are written in the TTI area.

In FIG. 9A, a part of the transmitter information (for example, a facsimile number of the transmitter) originally written in the received data has been deleted. However, the TTI can be added to an outer side of an original document, and the TTI attached originally at the transmission or reception can be added together with the archive information and displayed. Alternatively, in addition to the archive information, the manufacturer of the device (TTI example: Archive: Murata Kikai Kabushiki Kaisha) may be displayed. Alternatively, the TTI of the original received data may be deleted and simply, “Archive” may be displayed.

As shown in FIG. 9B, in the archive data created by the attached file name for archive writing unit 307 of the archive data creating unit 351, characters of “ARC” (archive information) is additionally written in the file name area of the property area. Further, in FIG. 9B, a file type is a Portable Document Format (PDF) file, and the file name area includes the archive information, the file name (20040721131106_{—}1) written originally in the received data, a signal (_) connecting the archive information and the file name and an extension (pdf).

That is, when the archiving destination uses a communication method other than the facsimile method or the I-FAX method, and when the archiving destination uses the transfer method using electronic mail (the electronic mail method, or a shared folder method using a Server Message Block (SMB) or a File Transfer Protocol (FTP) or the like represented by a Scan-to-Email method), a character string for distinguishing that transmission data is the archive data is added to the original file name (an example of another file name: Archive_Test1.pdf).

Next, a description will be made of operation and effect of the communication terminal device according to one embodiment. Communication terminal device 200 has the same operation and effect as the communication terminal device 100. Since the description overlaps, a detail description of the operation and the effect of the communication terminal device 200 will be omitted. The communication terminal device 100 of this embodiment can create archive data which the operator of the device of the archiving destination can easily distinguish as the archive data. That is, the communication terminal device 100 is configured to add archive information to data such that the archive information is output visibly at the transfer destination of the archive data. Therefore, the operator of the communication terminal device 200 of the archiving destination can distinguish easily that the transferred data is the archive data. Specifically, when the communication method for the archiving destination is the facsimile method or the I-FAX method, the communication terminal device 100 adds information indicating an archive to the TTI area of the transmission data at the archive transmission. Therefore, when the data transmitted from the communication terminal device 100 to the communication terminal device 200 is the archive data, the archive information is displayed in the TTI area of the archive data transferred to the communication terminal device 200 of the archiving destination. As a result, the operator of the communication terminal device 200 can distinguish that the transferred data is the archive data just by confirming the TTI area of the printed out facsimile document. When the communication method for the archiving destination is the electronic mail method, the communication terminal device 100 adds information indicating an archive to the file name area of the transmission data at the archive transmission. Therefore, when the data transmitted from the communication terminal device 100 to the communication terminal device 200 is the archive data, the archive information is displayed in the file name of the archive data transferred to the communication terminal device 200 of the archiving destination. As a result, the operator of the communication terminal device 200 can distinguish that the transferred data is the archive data. That is, even when the communication method for the archiving destination is either one of the facsimile method, the I-FAX method and the electronic mail method, the operator of the communication terminal device 200 of the archiving destination can distinguish that the transfer data is the archive data. Therefore, a machine manufactured by another company that does not have the same specifications, in other others, a machine that is not the same typed machine, can be designated as the archiving destination. As a result, influence resulting from the difference in the plurality of the communication methods can be reduced. The communication terminal device 100 can carry out communication with a plurality of types of transmission destinations (other ends) and has outstanding versatility.

An embodiment of the present invention has been described with reference to the drawings. The above-described embodiment is an example of the present invention and various different configurations can be adopted.

For example, in the above-described embodiment, the communication terminal device 100 obtains the model information of the communication terminal device 200 stored in the storage device 119, and determines the communication method for the communication terminal device 200. However, this is not an aspect to be limited in particular. For example, the communication terminal device 100 may transmit a signal to the communication terminal device 200 for obtaining model information of the communication terminal device 200. In this case, the communication terminal device 200 that received the signal transmits the model information of the communication terminal device 200 to the communication terminal device 100. The communication terminal device 100 that received the model information can determine the model of the communication terminal device 200 in accordance with the received model information.

1-9. (canceled)

10. A communication terminal device, comprising:
a receiving unit which receives data from a remote device;
an archive data creating unit which processes the data into archive data by adding archive information to the data; and
a transfer unit which transfers the archive data to another remote device,
wherein the archive data creating unit is configured to add the archive information to the data such that the archive information is output visibly at a transfer destination of the archive data.

11. The communication terminal device according to claim 10, wherein the communication terminal device is a multi-function communication terminal device having a facsimile function and an electronic mail function, and
the archive data creating unit comprises:
a communication method determination unit which determines a communication method for the remote device;
a facsimile document writing unit which writes the archive information into a facsimile document area of the data when the communication method determination unit determines that the communication method is a facsimile method; and
a property writing unit which writes the archive information into a property area of the data when the communication method determination unit determines that the communication method is an electronic mail method.

12. The communication terminal device according to claim 11, wherein the facsimile document writing unit includes a transmitter information writing unit which writes the archive information into a transmitter information area of the facsimile document area.

13. The communication terminal device according to claim 11, wherein the property writing unit includes a file name writing unit which writes the archive information into a file name area of the property area.

14. A communication system, comprising:
a first communication terminal device comprising the communication terminal device of claim 10;
a second communication terminal device; and
a communication path which connects the first communication terminal device and the second communication terminal device, wherein
the second communication terminal device is configured to output the archive data received from the first communication terminal device under a state in which archive information included in the archive data is visible.
